(19) United States
(12) Patent Application Publication
(10) Pub. No.: US 2009/0205289 A1
(43) Pub. Date: Aug. 20, 2009

(54) APPARATUS FOR RING-SEALING CLOSURE ELEMENTS ON CONTAINERS

(75) Inventor: Paolo Tacchini, San Martino di Monte San Pietro (IT)

Correspondence Address: NIXON & VANDERHYE, PC, 901 NORTH GLEBE ROAD, 11TH FLOOR, ARLINGTON, VA, 22203, US

(73) Assignee: A-PACK TECHNOLOGIES SA, Courroux (CH)

(21) Appl. No.: 12/297,203

(22) PCT Filed: Apr. 13, 2007
(86) PCT No.: PCT/IB2007/000957

§ 371 Date: Feb. 19, 2009

(30) Foreign Application Priority Data
Apr. 13, 2006 (IT) BO2006A000277

(51) Int. Cl. B67B 3/14

(52) U.S. Cl. 53/334

(57) ABSTRACT

An apparatus for ring-sealing closure elements on respective containers and provided with a rotating turret, for supporting and holding containers and the respective closure elements, and comprising a ring-sealing arrangement movable in relation to containers for deforming an edge of closure elements on the periphery of the necks of containers; the ring-sealing arrangement is engaged with a cam by means of an articulated arrangement; the cam is movable in relation to turret along a direction of adjustment for adjusting a position of ring-sealing arrangement in relation to containers and comprises a cylindrical cam.

### CROSS-REFERENCE TO RELATED APPLICATIONS

This application is the U.S. national phase of International Application No. PCT/IB2007/000957, filed 13 Apr. 2007, which designated the U.S and claims priority to Italy Application No. B02006A000277, filed 13 Apr. 2006, the entire contents of each application is hereby incorporated by reference.

### DESCRIPTION

This invention concerns an apparatus for ring-sealing closures applied to containers, specifically, a ring-sealing apparatus suitable for blocking caps, capsules, locking rings and similar on respective containers.

The use of capsules or rings made of ductile metallic material, typically aluminium alloy, for blocking closure caps inserted in the mouths or openings of containers, such as bottles, syringes, carpules or similar containers, in the required position, is well known, especially in the pharmaceuticals packaging sector.

Each capsule is applied to a respective container in such a way as to press the cap against the mouth of the container, for a sealed closure.

For this reason, the cap is made of elastic and pliable material, such as rubber or silicone, and comprises a cylindrical part insertable into the mouth of the container and a ring-like part suitable for abutting an upper outer edge of said mouth.

The function of the capsule is to block the cap to the container, preventing possible accidental detachment, and, in any case, to prevent the opening of the container without first removing the aforementioned capsule.

The capsule substantially consists of a hollow cylindrical element, provided with a flat bottom, provided for abutting a closure cap, and a side wall which externally surrounds the neck of the container at its mouth.

The neck of the container is provided with a projection or ring-like collar, which extends radially outwards.

The capsule is blocked on the container by folding and deforming a lower edge of this side wall inwards, i.e. towards the neck of the container, until it abuts the ring-like projection.

The cap and capsule are usually separate elements but may be integrated in a single body.

In automatic packaging processes with high production speeds, ring-sealing apparatuses are used for blocking capsules applied previously to containers that are filled and capped.

Such apparatuses can be integrated in a filler/capper machine, or separate and independent machines can be constructed, placed downline of aforementioned filler/capper machine.

In general, the known ring-sealing apparatuses comprise a carousel or rotating turret provided with a plurality of ring-sealing heads, each of which is suitable for operating on a respective container.

Each ring-sealing head comprises one or more ring-sealing tools, typically consisting of circular blades provided for progressively abutting and then bending the lower edge of the capsule.

The tools are driven win an advancing motion substantially radial in relation to a longitudinal and vertical symmetry axis of the container.

Simultaneously with translation of tools, the container is driven to rotation around its own vertical axis so that the lower edge of the capsule applied is deformed completely throughout its circumference.

The radial advancement movement of the ring-sealing tools is generally made by means of cam mechanisms, in which the rotation movement of the ring-sealing turret is used.

One disadvantage of known ring-sealing apparatuses consists in the need to manually adjust the position of the tooling of each ring-sealing head, each time the size of the capsule and containers changes.

In particular, the different possible heights of containers require the adjustment of the vertical position of the tooling in relation to a containers supporting surface on the ring-sealing turret.

The various possible dimensions of the neck of the containers make it compulsory to modify the advancement stroke of each tool to prevent it from colliding with the neck during the working, thereby breaking or damaging the container, or bending the edge of the capsule defectively or incompletely.

These adjustment and fine tuning operations are complicated and require a lot of time. Moreover, because of human intervention, errors are always possible in the adjustment of the ring-sealing heads, consequently leading to incorrect and inaccurate fixing of the capsules and/or breakage of containers.

In special applications in the pharmaceutical field, the product packaging processes are required to be carried out in aseptic or sterile atmosphere, to prevent contamination of any kind, for example, microbiological, particulate etc. of the product to be packed.

For this purpose, the machines or packaging lines are inserted in sterile rooms or are provided with control or separation rooms or isolators, which separate a sterile internal process volume or ambient from the outer non sterile ambient or ambient with different degree of sterility.

The sterility of the process volume is guaranteed by the cleaning and sterility of each component and element contained inside it and by the presence of an adequate unidirectional flow of sterile air, filtered by suitable high efficiency filters (HEPA—High Efficiency Particulate Air).

The unidirectional air flow is formed of air streamlines which move in the same direction, almost parallel to one another and at a substantially equal speed, in order to create a uniform air current without turbulence. The air flow, descending from the top downwards, forms a sterile air source which drags with it the contaminating particles that may be present in the chamber and prevents them from rising from the bottom of the chamber.

The air flow, licking the containers vertically prevents the particles, which may be present in a portion of process volume under the containers, from rising upwards and entering the containers, thereby contaminating them.

For this purpose, mechanisms, operating parts and moving arrangement, which can generate contaminating particles because of their movement, are preferably placed under the containers to be packaged.

In the ring-sealing carousels of known apparatuses, the ring-sealing heads driving organs, and, in particular, the ring-sealing blades are fixed to an upper portion of the turret, in a position above the containers.

The driving organs comprise motion transmission mechanisms and drives, actuators and sensors, etc. which are usually contained inside casings and guards, which separate said organs from the ambient in which the ring-sealing takes place. Connecting elements project out of these casings for connecting the driving organs to the ring-sealing heads.

In case of applications in sterile atmosphere, the aforementioned casings are provided for sealing to isolate the driving device from the process volume to prevent its contamination.

However, the dimensions of these casings and their position above the containers generally cause a considerable disturbance and alteration of the unidirectionality and uniformity of the air flow at the containers.

In addition to this, the particles, if any, generated during the movement of the connecting elements, projecting from said casings and above the containers, can be dragged by the air flow on said containers, affecting the sterility. In fact, although the containers are fitted with caps, since, in the first step of ring-sealing, the latter are not yet compressed against the opening of the container, the closure is not hermetic and particles can possibly enter between the cap and the container.

One object of this invention is to improve the known ring-sealing apparatuses. Another object is to make a ring-sealing apparatus which makes it possible to adjust and register the working position of the ring-sealing tools automatically rapidly and precisely, according to the shape and dimensions of the containers and the relative closures.

A further object is to obtain an apparatus which makes it possible to move the ring-sealing tools in an accurate and precise manner, whatever the shape of the container and closure.

A still further object is to make a ring-sealing apparatus particularly suitable for applications in controlled atmosphere, wherein the process volume in which the ring-sealing is done is subjected to a one-way, uniform sterile air flow.

In a first aspect of the invention, an apparatus is provided for ring-sealing closure elements on respective containers, provided with a rotating turret for supporting and holding said containers and said respective closure elements, and a ring-sealing arrangement movable in relation to said containers for deforming an edge of said closure elements of the neck periphery of said containers, said ring-sealing arrangement being engaged to a cam by means of an articulated arrangement, said cam being movable in relation to said turret along a direction of adjustment for adjusting the position of said ring-sealing arrangement in relation to said containers wherein said cam comprises a cylindrical cam.

Owing to this aspect of the invention, it is possible to make a ring-sealing apparatus which makes it possible to adjust and enter the working position of a ring-sealing arrangement and thereby of the relative ring-sealing tools in an automatic, rapid and precise manner, on the basis of the size and dimensions of the containers as well as of the relative closure elements. Since the ring-sealing arrangement is always engaged to a guiding channel of a cam, the movement of the latter along the direction of adjustment leads to variation of the initial and final position of the ring-sealing tools. The working stroke of the tools on the other hand remains unchanged, as it is defined by the profile of the guiding channel itself.

The use of a cylindrical cam, provided with one or more guiding channels, makes it possible to obtain a high precision and accuracy of movements of ring-sealing tools.

The frame of a turret, configured for supporting the ring-sealing arrangement and also movable along said direction of adjustment, make it possible to adjust the vertical position of the ring-sealing tools in relation to the blocking arrangement in an automatic, rapid and fast manner. In particular, it is possible to adjust the distance of aforementioned tools in relation to a containers supporting surface on the basis of the height of the containers.

The ring-sealing apparatus of the invention makes it possible to move the ring-sealing tools in an accurate and precise manner, whatever the shape of the container and closure.

In a second aspect of the invention, a ring-sealing apparatus is provided, provided with a rotating turret comprising a movable blocking arrangement for supporting and holding containers and closure elements; movable ring-sealing arrangement for deforming an edge of said closure elements on the periphery of the necks of said containers; and a moving arrangement, an articulated arrangement and a cam for driving said blocking arrangement and said ring-sealing arrangement, wherein said turret comprises containment compartments provided below said containers and suitable for containing inside them said moving arrangement, said articulated arrangement and said cam.

Owing to this aspect of the invention, it is possible to obtain a ring-sealing apparatus particularly suitable for applications in sterile atmosphere. All the moving arrangement are, in fact, entirely arranged under the containers, inside container compartments which can be hermetically separated from an outer process environment, in which the ring-sealing operation is carried out.

The separation of the container compartments prevents possible contamination of any kind, for example, microbiological, particulate, etc., of the aforementioned process environment. Furthermore, since the movements of the blocking arrangement and of the ring-sealing arrangement occur in a zone under the containers present on the turret, particles, if any, which may be generated by said movements, are dragged downwards by a unidirectional air flow, without reaching a process zone in which blocking of the closure elements on containers occurs. Owing to the fact that the turret contains the assembly of mechanisms and organs necessary for the working of the apparatus, the moving arrangement, the articulated arrangement and the cam comprises the assembly of mechanisms and organs necessary for moving the entire ring-sealing apparatus.

The invention will be better understood and carried into effect with reference to the attached drawings, in which an embodiment is shown by way of non-limiting example, in which:

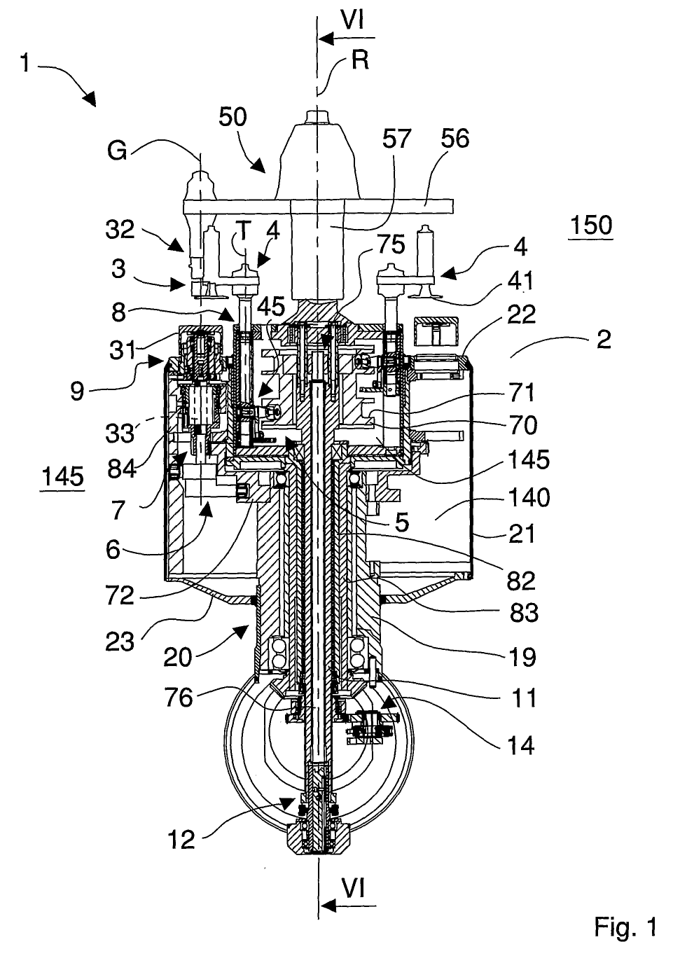

FIG. 1 is a longitudinal section of the ring-sealing apparatus of the invention;

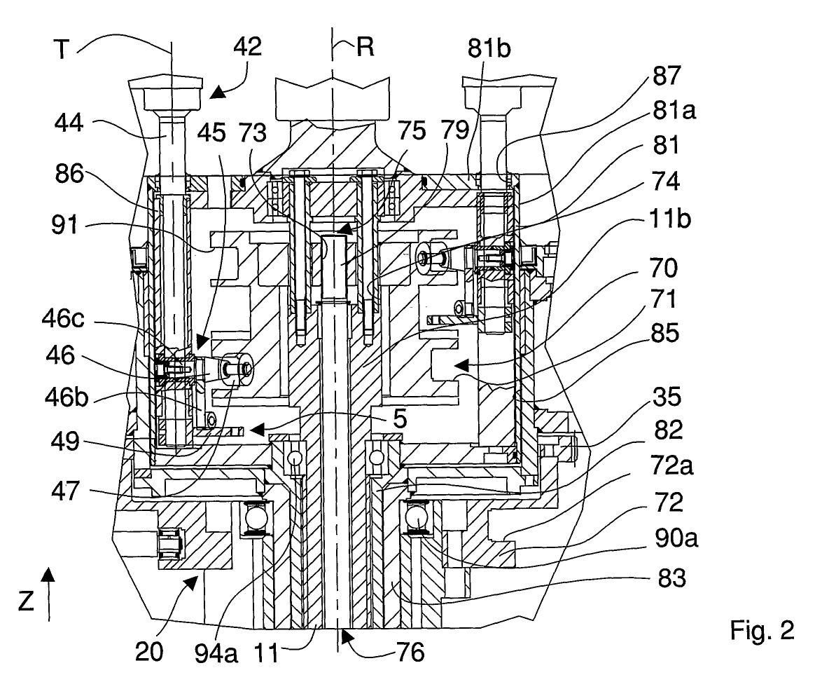

FIG. 2 is a partial and enlarged detail of FIG. 1, in which the cam and articulated arrangement of the ring-sealing apparatus are shown;

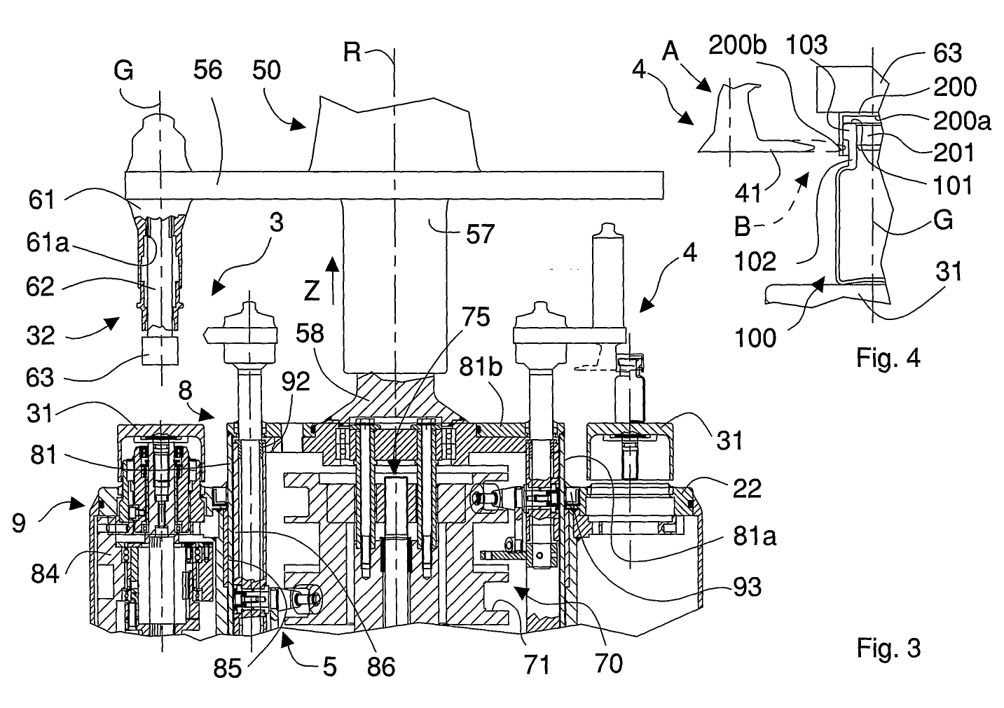

FIG. 3 is another partial and enlarged detail of FIG. 1, showing the supporting arrangement of a blocking arrangement of the apparatus;

FIG. 4 is a partial enlarged view of the ring-sealing arrangement in association with a container to be ring-sealed in an initial position, and in a final position, shown by a broken line;

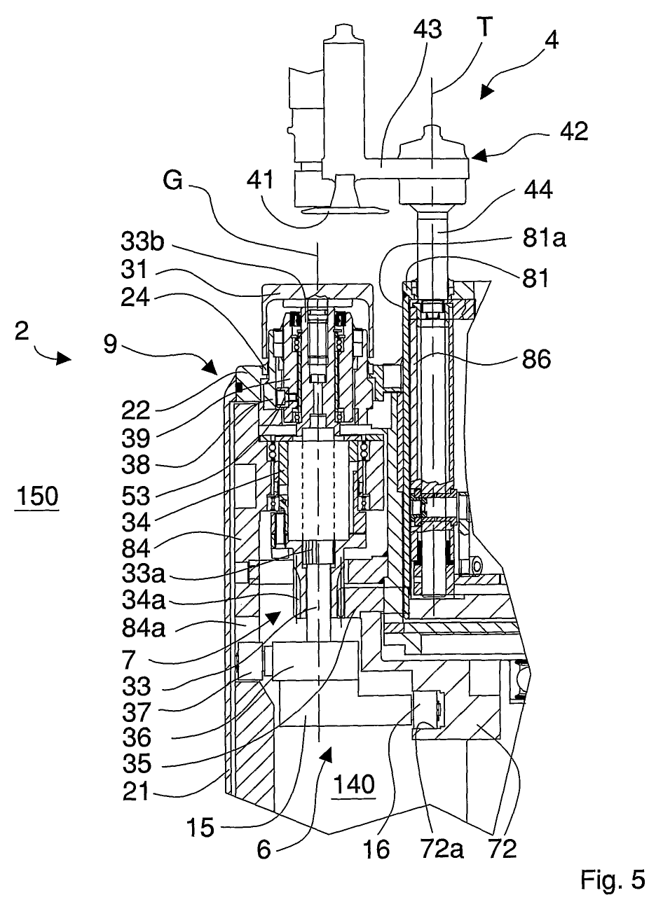

FIG. 5 is a further partial and enlarged detail of FIG. 1, showing the moving arrangement of the blocking arrangement;

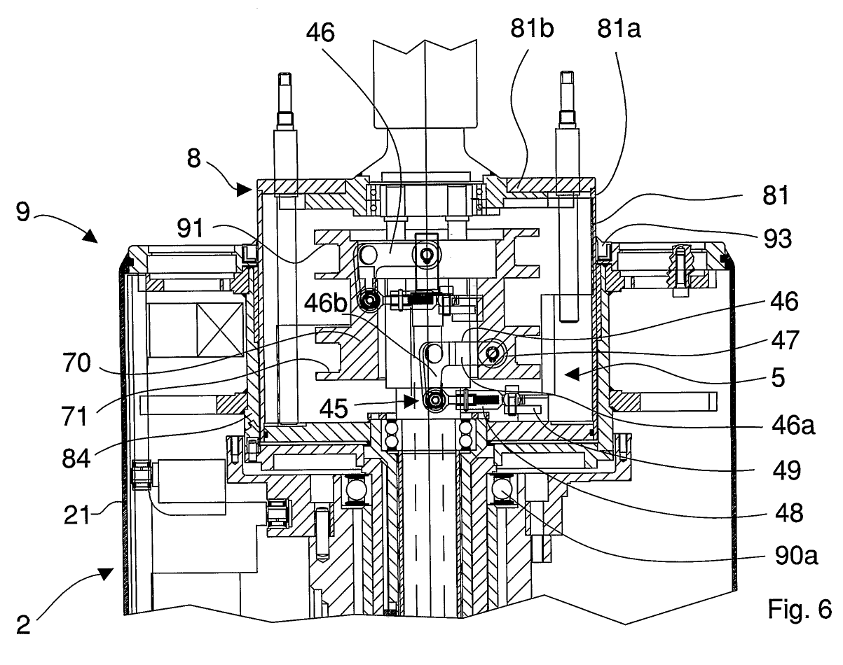

FIG. 6 is a partial enlarged section according to a plane VI-VI of FIG. 1, showing a cam and an articulated arrangement of a ring-sealing arrangement;

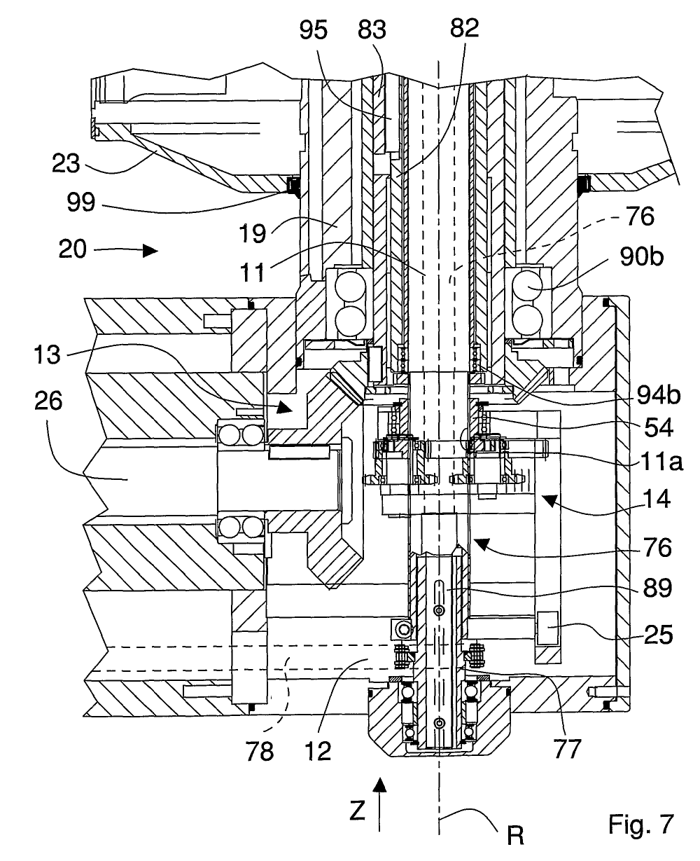

FIG. 7 is a further partial enlarged section according to the plane VI-VI of FIG. 1, showing the transmission arrangement of the apparatus;

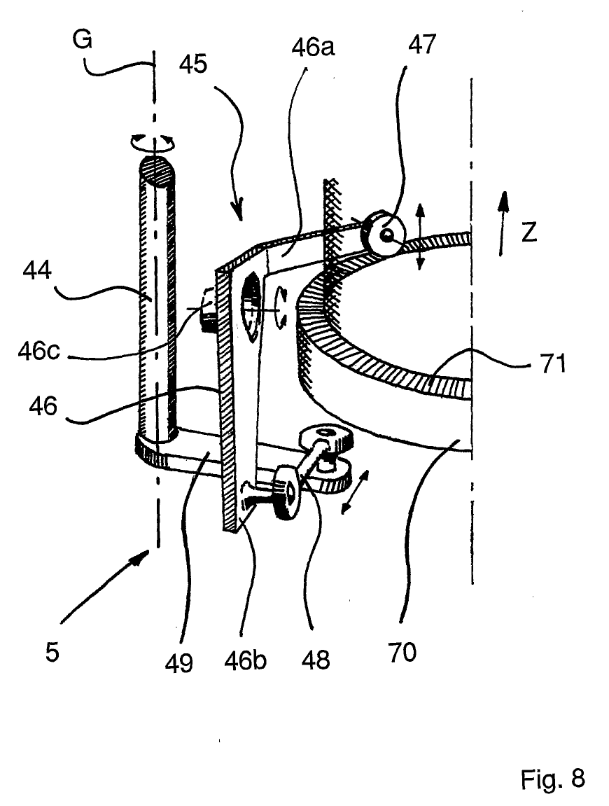

FIG. 8 is a schematic perspective view of an articulated arrangement engaged to a cam.

With reference to FIGS. 1 to 8, a ring-sealing apparatus 1 is shown, comprising a turret 2 rotating around a rotation axis R and provided with a blocking arrangement 3, suitable for supporting and holding containers 100 and respective closure elements 200, and a ring-sealing arrangement 4, movable in relation to said containers 100 for deforming an edge of said closure elements 200 on the periphery of the necks of said containers 100.

Ring-sealing apparatus 1 comprises a cam 70 suitable for moving the ring-sealing arrangement 4 by means of an articulated arrangement 5.

The cam 70 comprises a cylindrical or drum cam provided with one or more guiding channels 71, 91 provided for being engaged by rollers 47 of articulated arrangement 5.

The cam 70 is movable in relation to turret 2 along a direction of adjustment z for adjusting the position of ring-sealing arrangement 4 in relation to said containers 100.

The direction of adjustment Z is substantially parallel to rotation axis R.

First moving arrangement 75 is provided for moving the cam 70 and includes a first transmission arrangement 12 for connection to a respective driving device.

The closure elements 200 comprise known type of capsules or rings made of ductile metallic material, typically aluminium alloy, which are previously applied to containers 100, and, in particular, arranged above caps 201 inserted in containers 100.

Each capsule 200 consists of a hollow cylindrical element, provided with a flat bottom 200a, provided for abutting a corresponding cap applied to the container, and a side wall 200b, which externally surrounds a neck 102 of said container 100 at its mouth 101.

The neck of container 100 is provided with a ring-shaped projection, which extends radially outwards. Blocking of capsule 200 to container 100 is done by ring-sealing arrangement 4 by bending a lower free edge of side wall 200b inwards, i.e. towards the neck 102 of the container so that it abuts the ring-shaped projection 103.

The closure elements 200 can also be built into a single body with capsule and cap.

The blocking arrangement 3 and ring-sealing arrangement 4 are distributed angularly equidistant along a circumferentially peripheral edge of said turret 2 which, by rotating, are capable of supporting and at the same time moving a plurality of containers 100 with continuous or intermittent motion.

The turret 2 comprises a first frame 9 suitable for supporting the blocking arrangement 3 and a second frame 8 suitable for supporting the ring-sealing arrangement 4.

The first frame 9 and the second frame 8 are mounted coaxially and are rotatable, solidly connected, around rotation axis R.

In particular, the first frame 9 comprises a first upper portion 84 suitable for supporting and containing said blocking arrangement 3 and a first sleeve 83 supporting said first portion 84.

Similarly, the second frame 8 includes a second upper portion 81 suitable for supporting and containing the ring-sealing arrangement 4 and a second sleeve 82 supporting said upper element 81.

The first sleeve 82 is slidably inserted inside second sleeve 83 and angularly connected to the latter by means of a coupling member of known shape, for example, by means of a tab 95.

The first upper portion 84 of first frame 9 further comprises a cylindrical cavity 85, coaxial to rotation axis R and arranged for slidably containing the second upper portion 81 of second frame 8.

Second transmission arrangement 13 is provided for allowing the respective moving arrangement of apparatus 1, consisting, for example, of a known type of electric motor (not shown), to rotate said external supporting sleeve 83.

The second transmission arrangement 13 includes, for example, a pair of bevel gears arranged at the end of said first sleeve 83 and of a drive shaft 26 of the driving device, respectively.

The second frame 8 is capable of sliding axially in relation to first frame 9 along the direction of adjustment Z, to allow variation of the height of the ring-sealing arrangement 4 in relation to blocking arrangement 3, according to the dimensions and the shapes of containers 100.

Third frame 20 of apparatus 1 is provided for rotatably supporting the turret 2. More specifically, the third frame 20 comprises a fixed external supporting element 19 and a movable internal supporting element 11. The internal supporting element 11 consist of a third sleeve, blocked in rotation but free to slide along the direction of adjustment Z together with second frame 8.

The first frame 9 is rotatably supported by said external supporting element 19, by means of respective bearings 90a, 90b, while the second frame 8 is rotatably supported by internal supporting element 11, by means of respective bearings 94a, 94b.

Third transmission arrangement 14 is provided for connecting the internal supporting element 11 to respective driving device of apparatus 1, consisting, for example, of a type of electric motor known and not shown.

The third transmission arrangement 14 comprises a coupling member suitable for transforming a rotation motion of driving device in a translation motion of internal supporting element 11. Said member comprising, for example, a screw-lead screw type of coupling, wherein a volute or lead screw 54 is provided, arranged for engaging with a portion 11a of internal supporting element 11 and drivable in rotation by said driving device.

The rotation of lead screw 54, determines the translation of internal supporting element 11, prevented from rotating by a respective anti-rotation element 25.

The external supporting element 19 of third frame 20 makes it possible to support and fix the turret 2 to a fixed structure containing the only driving device, for example, rotating electric motors of ring-sealing apparatus 1.

Apparatus 1 may also be applied to a packaging machine, for example, a dosing and capping packaging machine, for making the ring-sealing operating station. In this case, the supporting element 19 allows to fix the turret 2 to a horizontal or vertical wall of a bench of said machine.

Since all the mechanisms and moving and adjustment organs of blocking arrangement 3 and of ring-sealing arrangement 4 are contained inside turret 2, there is no need to provide additional space inside the packaging machine apart from that necessary for the motors.

Each ring-sealing arrangement 4 comprises a ring-sealing tool 41, consisting, for example, of a circular blade mounted idly on respective supporting element 42, suitable for rotating around a respective axis of oscillation T for moving said tool 41 along a substantially curved trajectory.

The tool 41 completes a working stroke between an initial position A, wherein said tool 41 is disengaged and distant from closure elements 200, and a final position B, wherein said tool 41 has abutted a capsule 200, bending the lower free edge of the side wall 200b.

The oscillation axes T of supporting elements 42 are substantially parallel to rotation axes R.

Apparatus 1 has provision for a ring-sealing arrangement 4 to be associated with each blocking arrangement 3.

In an embodiment of apparatus 1 that is not shown, however, there is provision for two or more ring-sealing arrangement 4 to be associated with a same blocking arrangement 3 for working together on a same closure elements 200.

Each supporting element 42 comprises a supporting arm 43 and a supporting rod 44. One end of supporting arm 43 supports the corresponding ring-sealing tool 41, while the remaining end is fixed to rod 44.

The second frame 8 comprises a plurality of housings 86 arranged for receiving and rotatably supporting respective rods 44. In particular, said housings 86 are contained inside first upper portions 81 of said second frame 8, distributed angularly equidistantly along a side wall of the latter.

The housings 86 are in the form of cylindrical sleeves and are provided internally with plain bushes 92 for the relative rods 44.

Ring-sealing apparatus 1 comprises articulated arrangement 5 suitable for rotating the rods 44 and the relative ring-sealing tools 41.

The articulated arrangement 5 comprises a transferring arrangement 45 connected to said rods 44 and engaged by means of respective rollers 47 to one or more guiding channels 71, 91 of cylindrical cam 70.

The number of guiding channels present on cam 70 depends on the number of ring-sealing arrangement 4 to be driven, i.e. the angular distance between two successive transferring arrangement 45. A reduced angular distance, in case of numerous ring-sealing arrangement 4 to be controlled, does not, in fact, make it possible to engage all the transferring arrangement 45 to a same guiding channel. In the construction shown, the cam 70 comprises a lower channel 71 and an upper channel 91 substantially identical in which ring-sealing arrangement having rods 44 of two different lengths are engaged by means of transferring arrangement 45. The cam 70 are fixed and do not rotate with the turret 2 during the working of the ring-sealing apparatus 1. Therefore, it is the rotation of transferring arrangement 45 on cam 70 which determines a variation of the position of the transferring arrangement.

Each transferring arrangement 45 comprises an L-shaped first lever 46, provided with a first arm 46a and a second arm 46b substantially orthogonal to one another, and rotatably connected to second frame 8 by means of a fulcrum portion 46c. The latter is made at the junction of said arms and is found to be almost orthogonal to said second arm 46b.

The first lever 46 is pivoted to second frame 8 in such a way that, during its rotation the second arm 46b moves on a plane substantially parallel to the oscillation axis T and orthogonal to the section plane of FIG. 1.

The free end of the first arm 46a idly supports a roller 47, while the free end of second arm 46b is connected to a relative rod 44 of ring-sealing arrangement 4 by means of a joining element 48.

In particular, rod 44 is provided at its free end with a second lever 49 arranged for rotating, solidly connected, with rod 44 on a plane more or less orthogonal to oscillation axis T and to rotation plane of second arm 46b of first lever 46 (FIG. 8).

During the working of apparatus 1, the rotation of second frame 8 and therefore of ring-sealing arrangement 4 and of transferring arrangement 45 in relation to cam 70, determines a variation of position of transferring arrangement 45. In fact, the movement of roller 47 inside a respective channel 71, 91 causes the partial rotation of first lever 46. Each angular movement of first lever 46 has a corresponding angular movement of second lever 49 and therefore of ring-sealing tool 41.

There is a precise correlation between the linear-ascent and descent-movement of roller 47 of transferring arrangement 45 and the working stroke of ring-sealing tool 41.

It must be observed that the use of a cylindrical cam makes it possible to obtain considerable precision and accuracy of movements of transferring arrangement 45 and consequently of ring-sealing arrangement 4, by virtue of constant contact between roller 47 and channel 71, 91 and owing to reduced plays present.

The joining element 48 is a known type of elastic safety tie-rod, arranged for yielding elastically and varying the length, in order to absorb abnormal impact or stresses, if any, of ring-sealing arrangement 4 during the working and thus preserve the integrity of the more delicate and costly components, like the cam, the transferring arrangement 45, the supporting elements 42, in addition to the containers to be ring-sealed (FIG. 6).

The cam 70 is slidably supported by internal supporting element 11 and is movable in relation to the latter along the direction of translation Z.

In particular, the cam 70 has a cylindrical seat 74 arranged for engaging with an end portion 11b of said internal supporting element 11.

Since the internal supporting element 11 rotatably support the second frame 8, the cam 70 is found to be axially movable also in relation to ring-sealing arrangement 4 and to relative transferring arrangement 45. By changing the position along said direction Z of cam 70, it is, therefore, possible to change the initial and final angular position of ring-sealing tools 41, in accordance with the dimensions of the containers and the closures to be ring-sealed.

The first moving arrangement 75 comprises a positioning shaft 76 rotatably supported by internal supporting element 11 and connected to said cam 70 by means of a screw-lead screw type coupling.

In particular, the positioning shaft 76 has a first threaded end 79 configured for engaging a threaded hole 73 made in said cam 70. The rotation of positioning shaft 76 determines a translation of cam 70.

The positioning shaft 76 is inserted coaxially inside the internal supporting element 11 in such a way as to be able to translate solidly with these and at the same time be able to rotate freely.

In this manner, with the positioning shaft 76 kept blocked in rotation, when the supporting element 11 is driven along the direction of translation Z, these are capable of moving the second frame 8 and the cam 70 simultaneously and to the same extent, in such a way as to change the height of the ring-sealing arrangement 4 without modifying the initial and final position of the working stroke. The positioning shaft 76 is driven to rotation by respective driving device, consisting, for example, of a type of electric motor known and not shown, by means of the first transmission arrangement 12. The latter comprises, for example, a lower sleeve 77 inside which a second end 89 of said positioning shaft 76 is slidably inserted. The latter is solidly rotatable with sleeve 77 in virtue of a coupling of known shape, for example, by means of a tab or key. The lower sleeve 77 is rotatably supported by third frame 20 and is driven to rotation by driving device, for example, by means of a chain or toothed belt 78.

Each blocking arrangement 3 comprises a supporting plate 31, suitable for supporting a container 100, and an overhanging abutting element 32. The supporting plate 31 and the abutting element 32 are substantially coaxial in relation to a longitudinal ring-sealing axis G of said blocking arrangement 3, which is almost parallel to rotation axis R of turret 2.

The plate 31 is movable axially in relation to abutting element 32 along said ring-sealing axis G, in such a way as to compress the closure elements 200 on the respective container 100. More precisely, the plate 31 and the abutting element 32 compress cap 202 between capsule 201 and the mouth 101 of container 100.

The plate 31 can also be made to rotate around the respective ring-sealing axis G, in such a way as to rotate the corresponding container 100 and allow the ring-sealing tool 41 to bend the lateral edge 201b of capsule 201 along the entire circumference.

Second moving arrangement 6 is provided for moving the plate 31 axially along the respective ring-sealing axis G. The second moving arrangement 6 comprises a bracket 15 connected to a further cam 72. The latter is fixed in relation to turret 2, as it is fixed to external supporting element 19 of third frame 20 (FIG. 5).

The bracket 15 is connected to plate 31 by means of a supporting shaft 33.

The further cam 72 consists, for example, of a cylindrical drum cam, provided with a respective guiding channel 72a in which a respective roller 16 of bracket 15 slides.

The rotation of bracket 15 around the further cam 72 brings about the raising or lowering of the supporting shaft 33 and, thereby, of the supporting plate 31, to an extent defined by the profile of channel 72a.

Third moving arrangement 7 is provided for driving to rotation the plate 31 around the respective rotation axis G.

The third moving arrangement 7 comprises a sleeve 34 rotatably supported by the external upper portion 84 of first frame 9 and slidably connected to supporting shaft 33 by means of a grooved type of coupling for transmitting a rotation torque to the latter.

The shaft 33 therefore comprises a coupling portion 33a provided with known type of grooved profiles.

The sleeve 34 is provided with a toothed part 34a suitable for engaging a toothed wheel 35 fixed to external supporting element 19 of third frame 20.

During the rotation of turret 2, the sleeve 34 solidly connected to it, in addition to rotating around rotation axis R, revolves around its longitudinal axis, coincident with the ring-sealing axis G, by virtue of meshing of its toothed part 34a with the fixed toothed wheel 35. The sleeve 34 is thus capable of transmitting a rotation torque to the shaft 33, while, at the same time, allowing it to slide freely.

The number of rotations of sleeve 34 depends on the meshing ratio between the toothed part 34a and the fixed toothed wheel 35.

The supporting shaft is slidably fixed and supported to bracket 15. Anti-rotation arrangement 37 fixed to bracket 15 prevents the latter from rotating following rotation of shaft 33.

The anti-rotation arrangement 37 engages a longitudinal slot 84a made in the external upper portion 84 and substantially parallel to ring-sealing axis G.

Apparatus 1 comprises a supporting arrangement 50 fixed to turret 2 and arranged for supporting the abutting elements 32 of blocking arrangement 3.

The aforementioned supporting arrangement 50 comprises a circular supporting plate 56 provided with a peripheral edge to which are fixed, angularly equidistant, the abutting elements 32 in such a way as to be aligned and coaxial to respective plates 31.

The plate 56 is provided centrally with a hub 57 fixed coaxially to a supporting pin 58 of upper covering element 22 of second frame 8. In this way, the plate 56 is solidly connected to second frame 8 and can rotate and translates in direction Z with the latter.

It is, therefore, possible to move the ring-sealing arrangement 4 and the butting elements simultaneously and to the same extent in relation to plates 31, to allow the apparatus to ring-seal containers 100 of different heights.

Each abutting element 32 comprises a further supporting sleeve 61 fixed to plate 56 and provided with an internal cylindrical seat 61a for rotatably housing a rod 62 at one end of which an abutting pad 63 is fixed, intended for contacting the closure elements 200.

The rod 62 and the pad 63 are coaxial to ring-sealing axis G of the respective blocking arrangement 3. The rod 62 is mounted idly on supporting sleeve 61 to allow disk 63 to rotate freely with the container 100 and the relative closure elements 200.

The turret 2 includes containment compartments 140, 145 configured for housing and containing the moving arrangement 6, 7, 75, the articulated arrangement 5 and the cams 70, 72, which include all driving and adjusting mechanisms and organs of blocking arrangement 3 and ring-sealing arrangement 4.

The aforementioned containment compartments 140, 145 are arranged under the containers 100, and more, precisely, under a supporting surface S of said containers, defined by supporting plates 31.

The containment compartments 140, 145 are hermetically separated from an external ambient 150, in which ring-sealing of closure elements 200 takes place, by means of a separating arrangement 21, 22, 23, 81, 81a, 81b.

The first frame 9 includes a first containment compartment 140 capable of containing the moving arrangement 6, 7 of said blocking arrangement 3. In particular, the aforementioned first containment compartment 140 is delimited by a respective containment arrangement comprising a cylindrical side wall 21, an upper covering element 22 and a lower covering element 23 fixed to first upper portion 84 of first frame 9.

The upper covering element 22 has an opening at the cavity 85 of first upper portion 84 to allow the second upper portion 81 of second frame 8 to project out partially. The lower covering element 23 has a respective opening for the passage of external supporting element 19, into which the sleeves 82, 83 and the positioning shaft 76 pass.

First sealing element 93 is interposed between the upper covering element 22 and the second frame 8 to ensure sealing also during their translation in the direction of adjustment Z.

Similarly, second sealing element 99, is interposed between the lower covering element 23 and the supporting element 19 to ensure sealing also during the rotation of turret 2.

The upper covering element 22 also has a plurality of holes 24, arranged for the passage of the connecting ends 33b of supporting shafts 33, projecting out of said compartment 140 to support respective plates 31.

Bushings 38, 39 is interposed between each connecting end 33b and the respective hole 24 to ensure sealing between the first containment compartment 140 and an external environment 150.

The bushings 38, 39 comprise an external bushing 38 fixed to first upper portion 84 of first frame 9 and an internal bushing 39, coaxial and slidable inside external bushing 38. The internal bushing 39 is connected to shaft 33, such as to be slidable solidly connected to the latter, but blocked in rotation by respective anti-rotation arrangement 53.

Sealing element is interposed between said bushings 38, 39 and between the internal bushing and the shaft 33.

The second frame 8 forms a second containment compartment 145, inside which are housed the cam 70, the moving arrangement 75 and the articulated arrangement 5 for driving and adjustment of ring-sealing arrangement 4.

The second containment compartment 145 is substantially defined by a cylindrical side wall 81a and an upper wall 81b of second upper portion 81.

The cylindrical side wall 81a is abutted by first sealing element 93.

The upper wall 81b has a plurality of respective holes 87 for the passage of supporting rods 44 of respective ring-sealing arrangement 4. Sealing gaskets are provided in said holes 87 to ensure sealing during the rotation of rods 44.

It is important to highlight that the containment compartments 140, 145 are separated hermetically from the external process environment 150, so the ring-sealing apparatus of the invention is found to be particularly suitable for applications in the pharmaceutical and/or food sector, wherein the packaging operations and therefore the ring-sealing of containers must be carried out in controlled atmosphere subjected to a unidirectional, vertical flow of aseptic/sterile air.

The separation of the container compartments 140, 145, in fact, prevents possible contamination of any kind, for example, microbiological, particulate, etc., of the aforementioned process environment 150.

It is also observed that the movement of blocking arrangement 3 and of ring-sealing arrangement 4 occurs in a zone under the containers 100 present on turret 2. In fact, the supporting plates 31 are rotated and moved axially along the respective ring-sealing axes G by means of rotation and translation of respective connecting shafts 33, projecting out of first containment compartment 140.

The rotation of ring-sealing arrangement 4 takes place in virtue of the rotation of relative supporting rods 44 projecting out of second containment compartment 145.

Consequently, particles, if any, generated during the movement of said shafts 33 and rods 44 are dragged downwards by the unidirectional air flow present in the process environment, without reaching a working zone in which the blocking of closure elements 200 to containers 100 occurs.

1.-98. (canceled)

99. Apparatus for ring-sealing closure elements on respective containers provided with a rotating turret, for supporting and holding said containers and said respective closure elements, and comprising a ring-sealing arrangement movable in relation to containers for deforming an edge of closure elements on the periphery of the necks of said containers, said ring-sealing arrangement being engaged to a cam by means of an articulated arrangement, said cam being movable in relation to said turret along a direction of adjustment for adjusting a position of said ring-sealing arrangement in relation to said containers wherein said cam comprises a cylindrical cam.

100. Apparatus according to claim 99, wherein said turret further comprises a blocking arrangement for supporting and retaining said containers and said respective closures.

101. Apparatus according to claim 100, wherein said turret comprises a first frame suitable for supporting the blocking arrangement and a second frame suitable for supporting said ring-sealing arrangement, said turret being slidably supported by a third frame of said apparatus.

102. Apparatus according to claim 101, wherein said second frame is movable in relation to said first frame along said direction of adjustment for moving at least said ring-sealing arrangement in relation to said blocking arrangement.

103. Apparatus according claim 101, wherein said third frame comprises external supporting element fixed for rotatably supporting said first frame and internal supporting element movable axially along said direction of adjustment for supporting and moving said second frame.

104. Apparatus according to claim 103, wherein said cam is slidably coupled to said internal supporting element.

105. Apparatus according to claim 104, comprising a first moving arrangement suitable for translating said cam in relation to said internal supporting element along said direction of adjustment.

106. Apparatus according to claim 99, wherein said ring-sealing arrangement is rotatable around respective oscillating axes, substantially parallel to said direction of adjustment, in such a way as to rotate respective ring-sealing tools along substantially curved trajectories, suitable for abutting and deforming a side edge of said closure elements.

107. Apparatus according to claim 100, wherein each blocking arrangement comprises a supporting plate and an overhanging abutting element, said plate being movable for supporting and compressing a container provided with closure elements against said abutting element.

108. Apparatus according to claim 107, wherein said supporting plate and said respective abutting element are substantially coaxial to a respective ring-sealing axis substantially parallel to said direction of adjustment.

109. Apparatus according to claim 108, comprising a second moving arrangement suitable for axially moving said supporting plate along said ring-sealing axis and a third moving arrangement suitable for rotating said supporting plates around the respective ring-sealing axes.

110. Ring-sealing apparatus provided with a rotating turret comprising:
a movable blocking arrangement for supporting and holding containers and closure elements,
a movable ring-sealing arrangement for deforming an edge of said closure elements on the periphery of the necks of said containers, and
moving arrangement, an articulated arrangement and cams for driving said blocking arrangement and said ring-sealing arrangement,
wherein said turret comprises containment compartments arranged under said containers for containing said moving arrangement, said articulated arrangement and said cams.

111. Apparatus according to claim 110, wherein said containment compartments are hermetically separated from an external ambient in which ring-sealing of closure elements takes place, by means of separating arrangement.

112. Apparatus according to claim 111, wherein said turret comprises a first frame suitable for supporting said blocking arrangement, and a second frame suitable for supporting said ring-sealing arrangement, said turret being rotatably supported by a third frame of said apparatus.

113. Apparatus according to claim 112, wherein said first frame includes a first containment compartment capable of containing moving arrangement and cam suitable for moving said blocking arrangement.

114. Apparatus according to claim 113, wherein said first containment compartment is delimited by respective separating arrangement comprising a side wall, an upper covering element and a lower covering element, said separating arrangement being fixed to said first frame.

115. Apparatus according to claim 112, wherein said second frame includes a second containment compartment capable of containing a first moving arrangement, an articulated arrangement and a cam suitable for moving said ring-sealing arrangement.

116. Apparatus according to claim 115, wherein said second containment compartment is delimited by a respective separating arrangement comprising a respective side wall and an upper wall of a second upper portion of second frame.

117. Packaging machine comprising a ring-sealing apparatus according to claim 99.
